(19) United States
(12) Patent Application Publication
(10) Pub. No.: US 2025/0046184 A1
(43) Pub. Date: Feb. 6, 2025

(54) SERVER, SYSTEM, METHOD, AND COMPUTER READABLE STORAGE MEDIUM

(71) Applicants: HONDA MOTOR CO.,LTD., Tokyo (JP); SoftBank Corp., Tokyo (JP)

(72) Inventors: Moriya HORIUCHI, Saitama (JP); Takahiro KUREHASHI, Saitama (JP); Yuta SAKAGAWA, Saitama (JP); Koichi SERIZAWA, Tokyo (JP); Koyo ENOMOTO, Tokyo (JP)

(21) Appl. No.: 18/786,502

(22) Filed: Jul. 28, 2024

(30) Foreign Application Priority Data
Jul. 31, 2023 (JP) 2023-124145

(51) Int. Cl. G08G 1/0967; G08G 1/01

(52) U.S. Cl. CPC G08G 1/096775; G08G 1/012; G08G 1/0137

(57) ABSTRACT

A system includes a risk area identification unit which identifies a risk area external to a movable object; a retention control unit which performs control to retain positional information of two points of the risk area; and a determination unit which determines whether a first area identified from positional information of the two points that has already been retained through control by the retention control unit matches a second area identified from positional information of two points of a new risk area, when the risk area identification unit identifies the new risk area; wherein the retention control unit performs control to update positional information of the two points that has already been retained with the positional information of the two points of the new risk area when the determination unit determines that the first area matches the second area.

The contents of the following patent application(s) are incorporated herein by reference: NO. 2023-124145 filed in JP on Jul. 31, 2023.

### BACKGROUND

### 1. Technical Field

The present invention relates to a server, a system, a method, and a computer readable storage medium.

### 2. Related Art

Patent Document 1 describes a system in which an MEC server manages a risk area, and the MEC server provides information on the risk area to each vehicle.

### PRIOR ART DOCUMENT

### Patent Document

Patent Document 1: Japanese Patent Application Publication No. 2021-140470

### BRIEF DESCRIPTION OF THE DRAWINGS

FIG. 1 schematically shows a usage scene of a system 10.

FIG. 2 shows the situation where an information processing device 24b included in a vehicle 20b transmits risk area information.

FIG. 3 shows the situation where an information processing device 64 included in the vehicle 60 requests positional information of a risk area.

FIG. 4 shows the situation where the information processing device 64 performs an inquiry related to the risk area.

FIG. 5 shows a system configuration of a vehicle 20a and a vehicle 20b.

FIG. 6 shows a system configuration of a server 52.

FIG. 7 schematically shows a risk area that a risk area identification unit 220a in the vehicle 20a identifies.

FIG. 8 schematically shows another example of a risk area that the risk area identification unit 220a identifies.

FIG. 9 is a diagram to describe a process to determine whether a first area 810 and a second area 820 indicate the same area.

FIG. 10 is a diagram to describe another process to determine whether a first area 810 and a second area 820 indicate the same area.

FIG. 11 is a diagram to describe another process to determine whether a first area 810 and a second area 820 indicate the same area.

FIG. 12 schematically shows the process flow related to the information processing method performed by the vehicle 20a, the vehicle 20b, and the server 52.

FIG. 13 schematically shows the process flow related to the information processing method performed by the server 52, the vehicle 60, and the terminal 82.

FIG. 14 shows an example of a computer 2000.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solution of the invention.

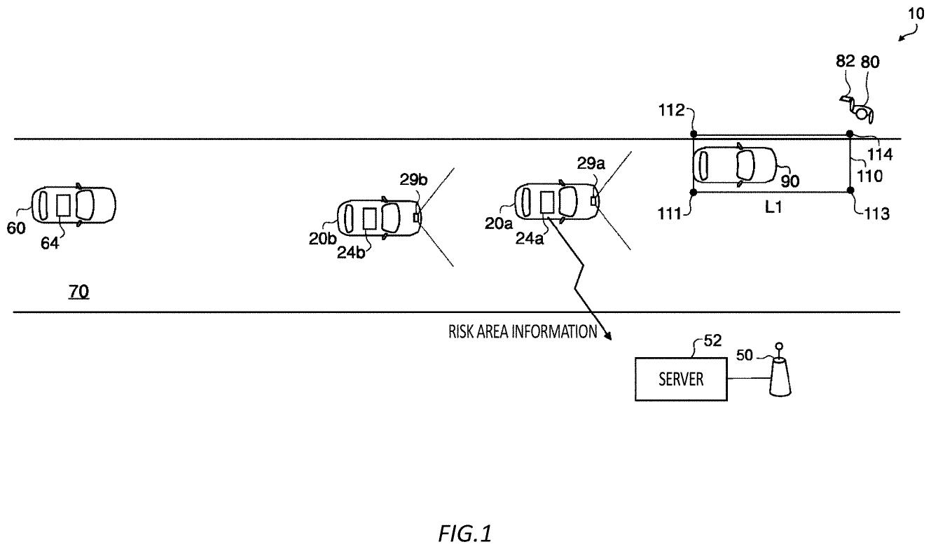

FIG. 1 schematically shows a usage scene of a system 10. The system 10 includes a vehicle 20a, a vehicle 20b, a vehicle 60, a terminal 82, a base station 50, and a server 52.

The vehicle 20a, the vehicle 20b, and the vehicle 60 are the vehicles driving on a road 70. The vehicle 20a, the vehicle 20b, and the vehicle 60 are examples of a movable object. The vehicle 20a includes an information processing device 24a and a sensor 29a. The sensor 29a is configured to include a camera. The information processing device 24a includes a function to process the information acquired by the sensor 29a and a communication function to communicate with the server 52 external to the vehicle 60. The sensor 29b is configured to include a camera. The information processing device 24b includes a function to process the information acquired by the sensor 29b and a communication function to communicate with the server 52. The vehicle 20a and the vehicle 20b are vehicles including, for example, an advanced driver assistance system (ADAS) function. The vehicle 20b includes the information processing device 24b and the sensor 29b. In the present embodiment, the vehicle 20a and the vehicle 20b are sometimes collectively referred to as “vehicle 20”. The vehicle 60 includes an information processing device 64. The information processing device 64 has a communication function to communicate with the server 52. The vehicle 60 is a vehicle that does not have the ADAS function, for example.

The terminal 82 is a terminal possessed by a person 80. The terminal 82 is, for example, a mobile terminal such as a smartphone. The base station 50 is a base station for mobile communication. The server 52 is a server connected to the base station 50. The server 52 may include an edge computing server such as a mobile edge computing (MEC) server, for example. The server 52 continuously manages positional information of the terminal 82. It is to be noted that although FIG. 1 shows one server 52, the server 52 may be constituted by a plurality of servers respectively connected to a plurality of base stations on a one-on-one basis. The information processing device 24a may communication with a server near the vehicle 20a among a plurality of servers constituting the server 52 and the information processing device 24b may communicate with a server near the vehicle 20b among a plurality of servers constituting the server 52, and the information processing device 64 may communicate with a server near the vehicle 60 among a plurality of servers constituting the server 52.

In FIG. 1, the vehicle 20a, the vehicle 20b, and the vehicle 60 are the vehicles driving along the road 70. A vehicle 90 is a vehicle parked on the road 70. The vehicle 20b is driving behind the vehicle 20a in the same travel direction as that of the vehicle 20a. The vehicle 60 is driving behind the vehicle 20b in the same travel direction as that of the vehicle 20b.

For the vehicle 20a, the area 110 ahead of the parked vehicle 90 in the travel direction of the vehicle 20a is an area that is difficult to visually recognize from the position of the vehicle 20a. From the information such as the image ahead in the travel direction acquired by the sensor 29a, the information processing device 24a identifies the area 110 that is not visible from the vehicle 20a as a risk area.

For example, based on the recognition information of the image acquired by the sensor 29a, the information processing device 24a determines four vertexes of a rectangle area 110 including the position of the vehicle 90: a vertex 111, a vertex 112, a vertex 113, and a vertex 114. The vertex 113 is a point a distance L1 away from the vertex 111 in the travel direction of the vehicle 20a, which is determined based on the recognition information of the image. The vertex 114 is a point a distance L1 away from the vertex 112 in the travel direction of the vehicle 20a, which is determined based on the recognition information of the image. L1 is the distance determined according to the vehicle speed of the vehicle 20a.

To inquire of the server 52 whether the terminal 82 exists in the area 110, the information processing device 24a transmits, to the server 52, the risk area information including four vertexes: the vertex 111, the vertex 112, the vertex 113, and the vertex 114. In the example of FIG. 1, since the terminal 82 does not exist in the area 110 defined by the four vertexes: the vertex 111, the vertex 112, the vertex 113, and the vertex 114, the server 52 discards the inquiry information or transmits, to the vehicle 20a, the response information indicating that the terminal 82 does not exist.

The server 52 stores the coordinate information of the vertex 111 and the vertex 112, which are positioned closer to the vehicle 20a, among the four vertexes: the vertex 111, the vertex 112, the vertex 113, and the vertex 114, which are included in the risk area information received from the information processing device 24a, and provides it to other vehicles including the vehicle 20b or the vehicle 60 following the vehicle 20a.

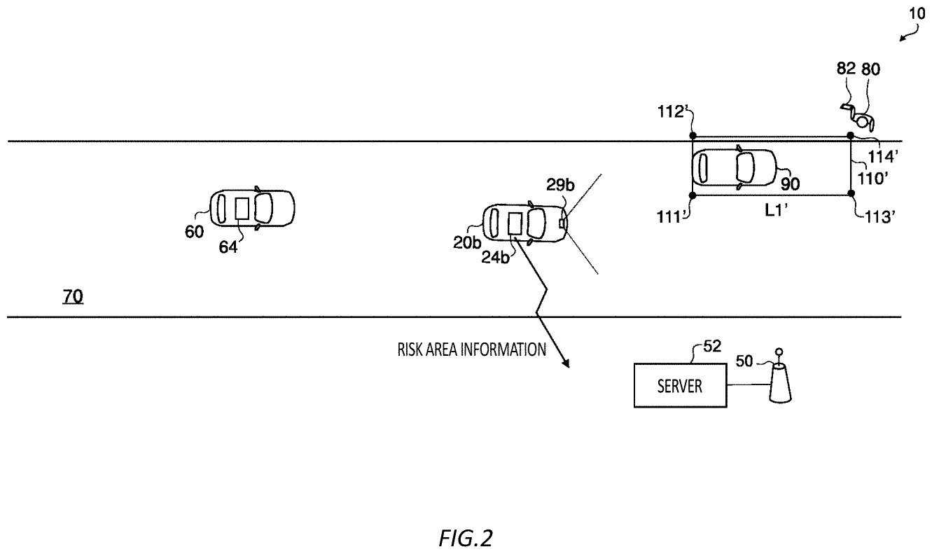

FIG. 2 shows the situation where an information processing device 24b included in the vehicle 20b transmits risk area information. Similar to the vehicle 20a, when the vehicle 90 is recognized by the sensor 29b, the vehicle 20b identifies a risk area 110′ and transmits, to the server 52, the risk area information including four vertexes in the identified risk area: a vertex 111′, a vertex 112′, a vertex 113′, and a vertex 114′. Based on the already stored coordinate information of the vertex 111 and the vertex 112 and the coordinate information of two vertexes included in the risk area information received from the vehicle 20b: a vertex 111′ and a vertex 112′, the server 52 determines whether the risk area identified by the vehicle 20b is the same area as the risk area identified by the vehicle 20a in the past. When determining that the risk area identified by the vehicle 20b is the same area as the risk area identified by the vehicle 20a in the past, the server 52 updates the coordinate information of the vertex 111 and the vertex 112 identified by the vehicle 20a with the coordinate information of the vertex 111′ and the vertex 112′ identified by the vehicle 20b. When it is determined that the risk area identified by the vehicle 20b is not the same area as the risk area identified by the vehicle 20a in the past, the coordinate information of two vertexes of the risk area 110′ closer to the vehicle 20b is added based on the information of the risk area 110′ identified by the vehicle 20b.

In general, when the vehicle 20a and the vehicle 20b have a difference in the equipment performance of the vehicle to recognize the risk area or when there is a difference between the driving environment of the vehicle 20a and the driving environment of the vehicle 20b, or due to other reasons, the coordinate information recognized as a risk area may have a difference even when the same risk area is recognized. According to the system 10 of the present embodiment, it can be determined appropriately whether the risk areas transmitted from the vehicle 20a and the vehicle 20b are the same, to update or add the coordinate information of the risk area.

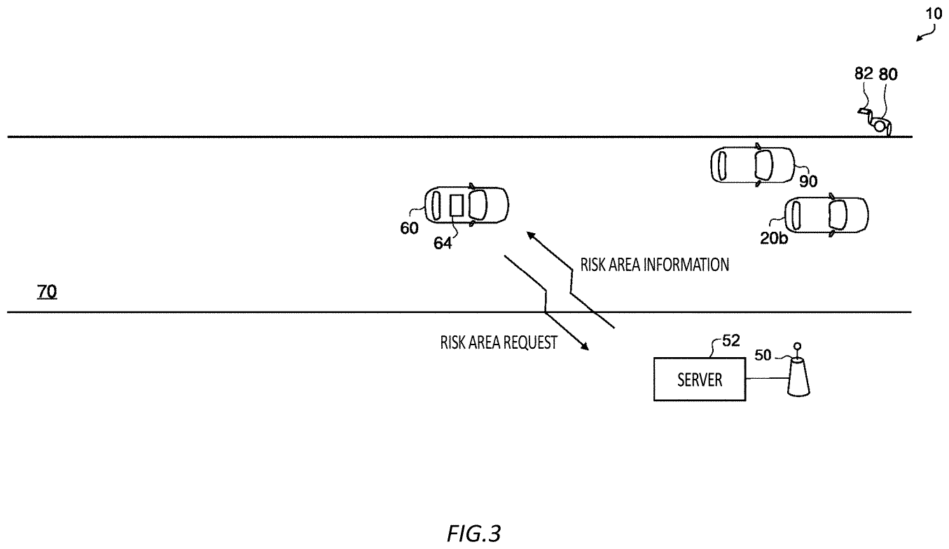

FIG. 3 shows a situation where the information processing device 64 included in the vehicle 60 requests positional information of a risk area. The information processing device 64 transmits a risk area request to the server 52 when being present in an area in which the information processing device 64 can communicate with the server 52. The server 52 transmits, to the information processing device 64, the stored coordinate information of the vertex 111′ and the vertex 112′ of the area 110. The information processing device 64 stores the coordinate information of the vertex 111′ and the vertex 112′ received from the server 52.

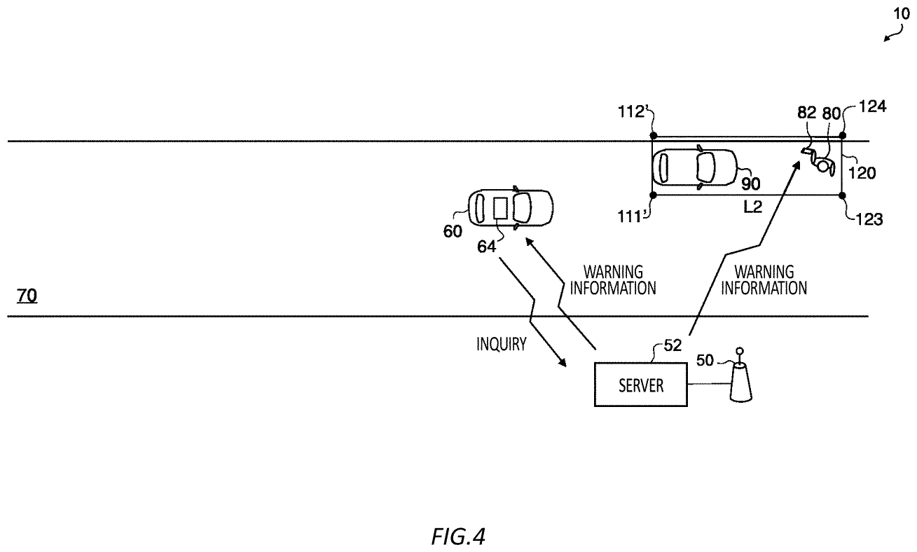

FIG. 4 shows a situation where the information processing device 64 performs an inquiry related to a risk area. When the distance from the vehicle 20 to the position indicated by the coordinate information of at least one of the vertex 111′ or the vertex 112′ becomes less than a predetermined distance, the information processing device 64 sets the area 120 defined by the vertex 111′, the vertex 112′, the vertex 123, and the vertex 124 as the risk area for the vehicle 60. For example, the information processing device 64 determines, as the vertex 123, a point a distance L2 away from the vertex 111′ in the travel direction from the vehicle 60 determined according to the vehicle speed of the vehicle 60 and determines, as the vertex 124, a point a distance L2 away from the vertex 112′ in the travel direction of the vehicle 60.

The information processing device 64 transmits, to the server 52, the risk area information including the coordinate information of the vertex 111′, the vertex 112′, the vertex 123 and the vertex 124 of the area 120 set as the risk area. When positional information of the terminal 82 managed by the server 52 is included in the area 120 surrounded by the vertexes included in the risk area information, the server 52 transmits warning information to the information processing device 64 and the terminal 82. Upon receiving the warning information from the server 52, the information processing device 64 outputs a warning to an occupant of the vehicle 60. For example, the information processing device 64 outputs a warning to the occupant using an HMI (Human Machine Interface) function of the vehicle 20. Accordingly, even when the information processing device 64 itself does not have a function of recognizing a risk area by sensing means such as a camera, the information processing device 64 can output a warning using the risk area received from the server 52 using a wireless communication function. In addition, upon receiving the warning information from the server 52, the terminal 82 outputs a warning to the person 80. For example, the terminal 82 outputs a warning to the person 80 using an HMI function of the terminal 82.

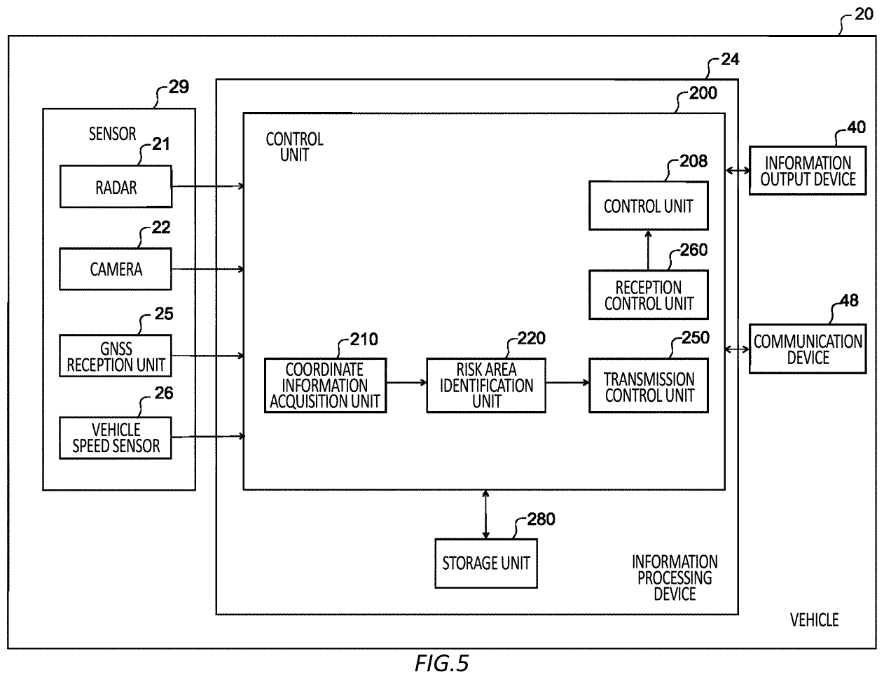

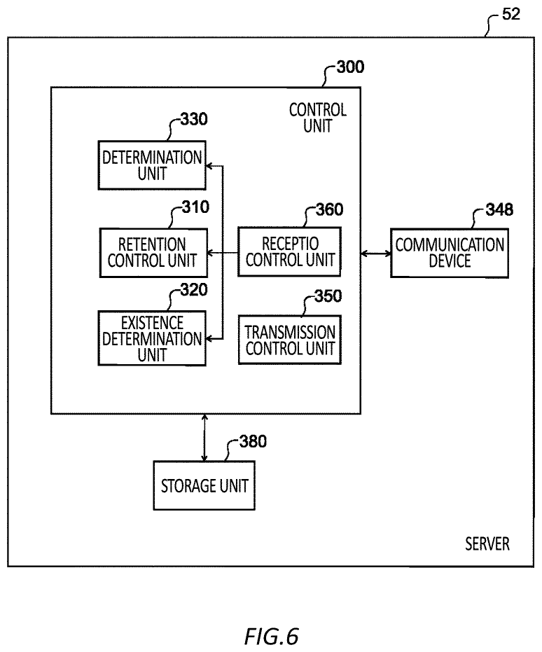

FIG. 5 shows a system configuration of the vehicle 20a and the vehicle 20b. The vehicle 20a and the vehicle 20b are collectively referred to as “vehicle 20”. The vehicle 20 includes the sensor 29, the information processing device 24, a communication device 48, and an information output device 40. In the figures following FIG. 6, for distinction, “a” is added to the end of the component of the information processing device 24a included in the vehicle 20a and “b” is added to the end of the component of the information processing device 24b included in the vehicle 20b.

The sensor 29 includes a radar 21, a camera 22, a GNSS reception unit 25, and a vehicle speed sensor 26. The radar 21 may be LiDAR, a millimeter wave radar, or the like. The GNSS reception unit 25 receives a radio wave transmitted from a GNSS (Global Navigation Satellite System) satellite. The GNSS reception unit 25 generates information representing a current position of a vehicle 20 based on a signal received from the GNSS satellite. The camera 22 is an example of an image-capturing device mounted on the vehicle 20. The camera 22 captures surroundings of the vehicle 20 and generates image information. For example, the camera 22 captures an image in a travel direction of the vehicle 20 and generates the image information. The camera 22 may be a monocular camera. The camera 22 may also be a compound eye camera or a camera that can acquire information on a distance to an object. The camera 22 recognizes an object based on an image acquired by an image capturing function, and outputs positional information of the recognized object. The vehicle speed sensor 26 is configured to detect a vehicle speed of the vehicle 20. It should be noted that the sensor 29 may include a position sensor such as an odometer and an IMU (inertial measurement unit) such as an acceleration sensor and a posture sensor.

It is to be noted that the vehicle 20 may include a driver assistance control device that performs driver assistance of the vehicle 20 using information detected by the sensor 29. The driver assistance control device may be realized by an ECU that provides the ADAS function.

The communication device 48 is responsible for communication with the server 52. The communication device 48 may communicate with the server 52 by mobile communication. The communication device 48 may be communicable through an interface for communication via a mobile base station for vehicle-to-vehicle communication (Uu), for example.

The information output device 40 is a device that outputs the warning information. The information output device 40 may have an HMI function. The information output device 40 may include a head-up display and a navigation system. The information output device 40 may be a mobile terminal that is carried by the occupant of the vehicle 20. The information output device 40 may include a sound output device configured to output the warning information by a sound.

The information processing device 24 includes a control unit 200 and a storage unit 280. The control unit 200 is realized by, for example, a circuit of an arithmetic processing device including a processor, and the like. The storage unit 280 is realized to include a non-volatile storage medium. The control unit 200 performs processing by using information stored in the storage unit 280. The control unit 200 may be implemented by an ECU (Electronic Control Unit) having a microcomputer including a CPU, ROM, RAM, 1/O, bus, and the like.

The control unit 200 includes a coordinate information acquisition unit 210, a risk area identification unit 220, a control unit 208, a transmission control unit 250, and a reception control unit 260. It is to be noted that an embodiment may be adopted in which the control unit 200 does not have some functions in the functional blocks shown in FIG. 5. For example, an embodiment may be adopted in which only a part of functions is implemented in the control unit 200, and the other function is implemented as a function of the sensor 29 or the other circuit.

The risk area identification unit 220 identifies a risk area outside the vehicle 20. The transmission control unit 250 performs control for transmitting risk area information representing a risk area identified by the risk area identification unit 220 to the server which retains information related to the risk area. The risk area identification unit 220 may identify the area defined by a plurality of points as the risk area and the transmission control unit 250 may perform control to transmit the coordinate information of the plurality of points as the risk area information to the server 52. The plurality of points defining the risk area may be the plurality of vertexes defining the area identified as the risk area. The plurality of points defining the risk area may be the plurality of vertexes defining the polygonal area identified as the risk area.

It is to be noted that the risk area may be an area outside the vehicle 20, which becomes a risk regarding a movement of the vehicle 20. The risk area may be an area that cannot be clearly viewed from the position of the vehicle 20 due to an object outside the vehicle 20. The area that cannot be clearly viewed is, for example, positional information of an area where occlusion has occurred due to blocking by a three-dimensional object such as another vehicle, a building, and a roadside tree when seen from the position of the vehicle 20.

The coordinate information acquisition unit 210 acquires coordinate information of an object recognized from an image acquired by capturing an outside of the vehicle 20 by the camera 22 mounted on the vehicle 20. The risk area identification unit 220 may identify the risk area based on the coordinate information of the object recognized from the image acquired by capturing the outside of the vehicle 20 by the camera 22.

The coordinate information may include, as coordinates of each of a plurality of points defining the position of the object, first relative coordinates in a first direction along the travel direction of the vehicle 20 and second relative coordinates in a second direction intersecting with the first direction. The second direction may be a direction orthogonal to the first direction. The number of the plurality of points may be three or more. The risk area identification unit 220 may identify an area defined by the three or more points included in the coordinate information as the risk area based on the coordinate information of the object recognized from the image capturing the outside of the vehicle 20.

The control unit 208 may perform control to execute driver assistance of the vehicle 20 or warning to the occupant of the vehicle 20. For example, when the information output device 40 includes a head-up display, the control unit 208 may cause the head-up display of the vehicle 20 to output light for forming a mark as warning information indicating that a pedestrian is present in the risk area. In addition, the control unit 208 causes the head-up display to output light for forming a mark in a display area corresponding to a position of the risk area in which the pedestrian is present. The control unit 208 may project the light for forming a mark towards a reflective part provided to a windshield of the vehicle 20. It should be noted that the control unit 208 may output the warning information by a sound or a character. Further, the control unit 208 may control driving of the vehicle 20 through the driver assistance control device included in the vehicle 20.

FIG. 6 shows a system configuration of the server 52. The server 52 includes a communication device 348, a control unit 300, and a storage unit 380.

The control unit 300 controls the communication device 348. The communication device 348 is responsible for communication with the terminal 82 and the information processing device 24. The control unit 200 is realized by, for example, a circuit of an arithmetic processing device including a processor, and the like. The storage unit 380 is realized by including a non-volatile storage medium. The control unit 300 performs processing by using information stored in the storage unit 380. The control unit 300 may be realized by a microcomputer including a CPU, a ROM, a RAM, an 1/O, a bus, and the like.

The control unit 300 includes a retention control unit 310, an existence determination unit 320, a determination unit 330, a transmission control unit 350, and a reception control unit 360. It is to be noted that an embodiment may be adopted in which the control unit 300 does not have some functions in the functional blocks shown in FIG. 6.

The reception control unit 360 performs control for receiving risk area information representing a risk area outside the vehicle 20, that has been identified by the vehicle 20. The retention control unit 310 performs control to retain the positional information of two points of the risk area. For example, the retention control unit 310 causes the storage unit 380 to store the positional information of two points of the risk area indicated by the risk area information. The risk area information may include a plurality of points defining the risk area. The retention control unit 310 causes the storage unit 380 to store the positional information of two points among a plurality of points of the risk area indicated by the risk area information.

When a new risk area is identified by the risk area identification unit 220, the determination unit 330 determines whether a first area identified from the positional information of two points already retained through the control by the retention control unit 310 matches a second area identified from the positional information of two points of the new risk area. When the determination unit 330 determines that the first area matches the second area, the retention control unit 310 performs control to update the already retained positional information of the two points with the positional information of the two points of the new risk area.

When the determination unit 330 determines that the first area does not match the second area, the retention control unit 310 performs control to newly retain the positional information of the two points of the new risk area. When the determination unit 330 determines that the first area does not match the second area, the retention control unit 310 may perform control not to update the positional information of the two points retained through the control by the retention control unit 310 but newly retain the positional information of the two points of the risk area indicated by new risk area information.

When the risk area identification unit 220 identifies a new risk area, the retention control unit 310 determines the positional information of a first plurality of points defining the first area based on the already retained positional information of two points and determines the positional information of a second plurality of points defining the second area based on the positional information of the two points of the risk area indicated by new risk area information. The determination unit 330 determines whether the first area matches the second area based on the degree to which the first area defined by the first plurality of points overlaps with the second area defined by the second plurality of points.

The determination unit 330 may determine whether the first area matches the second area based on the overlapping area of the first area and the second area. The determination unit 330 may determine whether the first area matches the second area based on the area ratio of the partial area where the first area and the second area overlap with each other to at least one of the first area or the second area. The determination unit 330 may determine whether the first area matches the second area based on the amount of misalignment between the position of the center of gravity of the first area and the position of the center of gravity of the second area.

The determination unit 330 may determine whether the first area matches the second area based on the amount of misalignment between the plurality of points defining the first area and the plurality of points defining the second area. For example, the determination unit 330 may determine whether the first area matches the second area based on at least one of the average value, the maximum value, or the minimum value of the amount of misalignment between the plurality of points defining the first area and the plurality of points defining the second area.

The transmission control unit 350 performs control to transmit, to another vehicle 20, the positional information of two points retained by the retention control unit 310.

The reception control unit 360 performs control to periodically receive the positional information of a plurality of terminals including the terminal 82. By storing the positional information of the plurality of terminals received under control of the reception control unit 360 in the storage unit 380, the server 52 manages the positional information of each of the plurality of terminals.

The reception control unit 360 receives the risk area information from the vehicle 20 or the vehicle 60. The risk area information is information transmitted from the vehicle 20 or the vehicle 60, and is information used for inquiring whether any of the terminals whose positional information is managed by the server 52 is present in the risk area. The risk area information may include all coordinates of a plurality of vertexes that define the risk area. Based on the positional information managed by the server 52, the existence determination unit 320 determines whether any of the terminals exist in the risk area defined by the plurality of vertexes included in the risk area information. When it is determined that any of the terminals exist in the risk area, the transmission control unit 250 performs control to transmit the response information indicating the existence of the terminal to the vehicle 20 or the vehicle 60 that transmitted the risk area information.

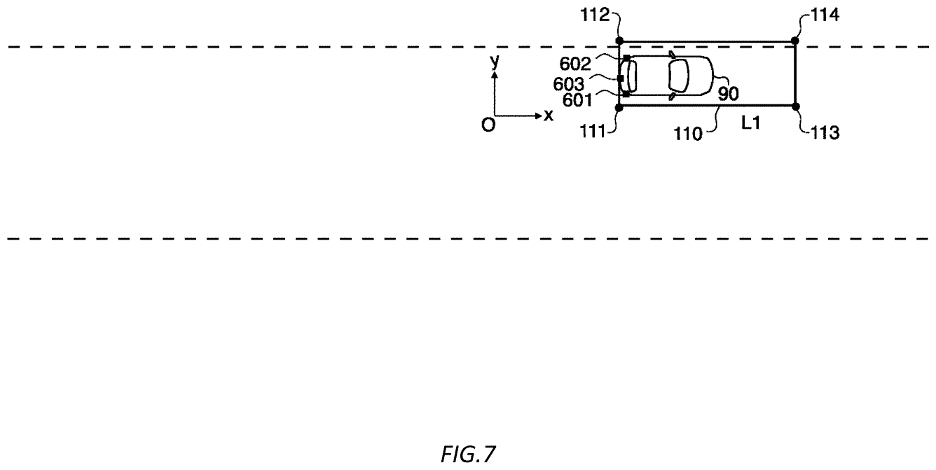

FIG. 7 schematically shows the risk area identified by the risk area identification unit 220a in the vehicle 20a. FIG. 7 shows an example of identifying a rectangular area as the risk area.

The sensor 29a outputs the coordinate information indicating the position at which the object recognized by the sensor 29a exists. For example, the sensor 29a outputs the coordinate information of the position at which the object exists in the coordinate system where, for example, the positive x-axis direction is the travel direction of the vehicle 20a and the y-axis direction is the direction parallel to the plane parallel to the road surface on which the vehicle 20a is driving and orthogonal to the x-axis. The origin O of the coordinate system is set at the position preset in the vehicle 20a. For example, in the example shown in FIG. 7, the sensor 29a outputs the coordinate information including the coordinate of the position 601, the coordinate of the position 602, and the coordinate of the position 603. The position 601 is the position furthest in the negative y-axis direction out of the positions at which the object has been recognized by the sensor 29a, the position 602 is the position furthest in the positive y-axis direction out of the positions at which the object has been recognized by the sensor 29a, and the position 603 is the position furthest in the negative x-axis direction out of the positions at which the object has been recognized by the sensor 29a. In other words, the position 603 is the position closest to the vehicle 20 out of the positions at which the object has been recognized by the sensor 29a.

The risk area identification unit 220a identifies the area 110 as the risk area based on the coordinate information acquired by the coordinate information acquisition unit 210a. The area 110 is a rectangular area defined by connecting the vertex 111, the vertex 112, the vertex 114, and the vertex 113. One side of the area 110 closer to the vehicle 20a is the side that includes the position 603 and is parallel to the y-axis. The one side of the area 110 closer to the vehicle 20a is defined by the vertex 111 and the vertex 112. The vertex 111 is determined at a position that is equal to the position 601 or that has passed beyond the position 601 by a predetermined amount in the negative y-axis direction. The vertex 112 is determined at a position that is equal to the position 602 or that has passed beyond the position 602 by a predetermined amount in the positive y-axis direction. In the example of FIG. 7, the vertex 111 is determined at the position that has passed beyond the position 601 by a predetermined amount in the negative y-axis direction and the vertex 112 is determined at the position that has passed beyond the position 602 by a predetermined amount in the positive y-axis direction. The vertex 113 is determined at a position away from the vertex 111 by the distance L1 in the positive x-axis direction. The vertex 114 is determined at a position away from the vertex 112 by the distance L1 in the positive x-axis direction. L1 is determined according to the vehicle speed of the vehicle 20. L1 is determined such that it becomes longer as the vehicle speed of the vehicle 20 becomes higher.

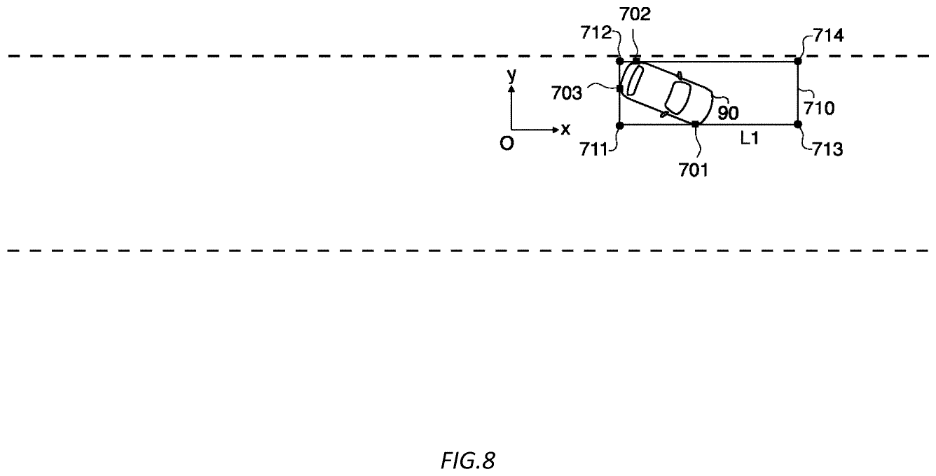

FIG. 8 schematically shows another example of the risk area identified by the risk area identification unit 220a. FIG. 8 shows another example of the rectangular area identified as the risk area.

In the example shown in FIG. 8, the sensor 29a outputs the coordinate information including the coordinate of the position 701, the coordinate of the position 702, and the coordinate of the position 703. The position 701 is the position furthest in the negative y-axis direction out of the positions at which the object has been recognized by the sensor 29a, the position 702 is the position furthest in the positive y-axis direction out of the positions at which the object has been recognized by the sensor 29a, and the position 703 is the position furthest in the negative x-axis direction out of the positions at which the object has been recognized by the sensor 29a. The position 703 is a position closest to the vehicle 20 out of the positions at which the object has been recognized by the sensor 29.

The risk area identification unit 220a identifies the area 710 as the risk area based on the coordinate information acquired by the coordinate information acquisition unit 210a. The area 710 is a rectangular area defined by connecting the vertex 711, the vertex 712, the vertex 714, and the vertex 713. One side of the area 710 closer to the vehicle 20a is the side that includes the position 703 and is parallel to the y-axis. One side of the area 710 closer to the vehicle 20a is defined by the vertex 711 and the vertex 712. The vertex 711 is determined at a position that is at least equal to the position 701 or that has passed beyond the position 701 by a predetermined amount in the negative y-axis direction. The vertex 711 is determined at a position that is at least equal to the position 702 or that has passed beyond the position 702 by a predetermined amount in the positive y-axis direction. In the example of FIG. 8, the vertex 711 is determined at a position that is equal to the position 701 in the negative y-axis direction and the vertex 712 is determined at a position that is equal to the position 702 in the positive y-axis direction. The vertex 713 is determined at a position away from the vertex 711 by the distance L1 in the positive x-axis direction. The vertex 714 is determined at a position away from the vertex 712 by the distance L1 in the positive x-axis direction.

As shown in FIG. 7 and FIG. 8, the risk area identification unit 220a identifies, as the risk area, the area including at least the position of the vehicle 90 recognized by the sensor 29a. FIG. 7 and FIG. 8 exemplify the case in which the risk area identification unit 220a identifies a rectangular area as the risk area. However, the area set by the risk area identification unit 220a as the risk area may be a rectangle area including a parallelogram or the like. The area set as the risk area by the risk area identification unit 220 may be a polygonal area.

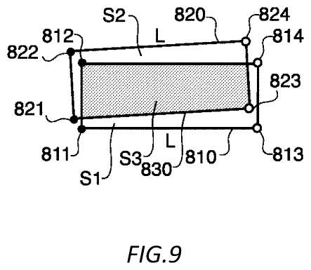

FIG. 9 is a diagram to describe a process to determine whether the first area 810 and the second area 820 indicate the same area. The first area 810 is the area defined by sequentially connecting the vertex 811, the vertex 812, the vertex 814, the vertex 813, and the vertex 811. The second area 820 is the area defined by sequentially connecting the vertex 821, the vertex 822, the vertex 824, the vertex 823, and the vertex 821. The vertex 811 and the vertex 812 of the first area 810 are the coordinate information included in the risk area transmitted from the vehicle 20a and the vertex 821 and the vertex 822 of the second area 820 are the coordinate information included in the risk area transmitted from the vehicle 20b.

The determination unit 330 determines the vertex 813 and the vertex 814. The retention control unit 310 sets, as the vertex 813, a point a preset distance L away from the position of the vertex 811 in the direction along the road 70. The determination unit 330 sets, as the vertex 814, a point a preset distance L away from the position of the vertex 812 in the direction along the road 70. In this way, the first area 810 and the second area 820 are defined.

The determination unit 330 calculates the area of the first area 810 and the area S3 of the overlapping area of the first area 810 and the second area 820. The determination unit 330 calculates the degree to which the first area 810 overlaps with the second area 830 based on the ratio of the area S1 of the first area 810 to the area S3 of the overlapping area 830 of the first area 810 and the second area 820 and determines whether the first area 810 and the second area 820 are the same area based on the calculated degree of overlapping. For example, the determination unit 330 calculates the ratio of the area S3 to the area S1 and determines that the first area 810 and the second area 820 are the same area when the ratio of the area S3 to the area S1 is equal to or more than a predetermined threshold. On the other hand, when the ratio of the area S3 to the area S1 is less than a predetermined threshold, the determination unit 330 determines that the first area 810 and the second area 820 are not the same area.

The determination unit 330 calculates the area S2 of the second area 820, calculates a degree to which the first area 810 overlaps with the second area 820 based on the ratio of the area S2 of the area 830 to the area S3 of the second area 820, and determines whether the first area 810 and the second area 820 are the same area based on the calculated degree of overlapping. For example, the determination unit 330 calculates the ratio of the area S3 to the area S2 and determines that the first area 810 and the second area 820 are the same area when the ratio of the area S3 to the area S2 is equal to or more than a predetermined threshold. On the other hand, when the ratio of the area S3 to the area S2 is less than a predetermined threshold, the determination unit 330 determines that the first area 810 and the second area 820 are not the same area.

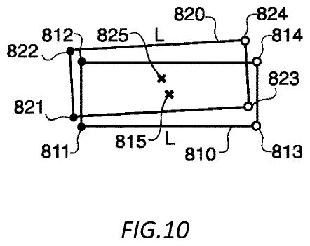

FIG. 10 is a diagram to describe another process to determine whether the first area 810 and the second area 820 indicate the same area. The determination unit 330 sets the vertex 813, the vertex 814, the vertex 823, and the vertex 824 by the same method as the method described in connection with FIG. 9.

The determination unit 330 calculates the position of the center of gravity 815 based on the coordinate information of the vertex 811, the vertex 812, the vertex 814, and the vertex 813 of the first area 810, and calculates the position of the center of gravity 825 based on the coordinate information of the vertex 821, the vertex 822, the vertex 823, and the vertex 824 of the second area 820. The determination unit 330 calculates the amount of misalignment of the position between the position of the center of gravity 815 of the first area 810 and the position of the center of gravity 825 of the second area 820. The determination unit 330 determines that the first area 810 and the second area 820 are the same area when the calculated amount of misalignment of the positions of the center of gravity is less than a predetermined threshold. On the other hand, the determination unit 330 determines that the first area 810 and the second area 820 are not the same area when the amount of misalignment of the positions of the center of gravity is equal to or more than the predetermined threshold.

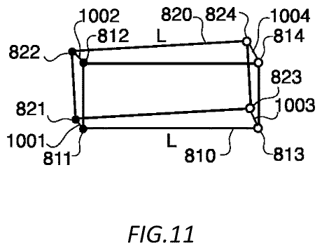

FIG. 11 is a diagram to describe another process to determine whether the first area 810 and the second area 820 indicate the same area. The determination unit 330 sets the vertex 813, the vertex 814, the vertex 823, and the vertex 824 by the same method as the method described in connection with FIG. 9.

The determination unit 330 calculates the amount of misalignment 1001 between the vertex 811 of the first area 810 and the vertex 821 of the second area 820, the amount of misalignment 1002 between the vertex 812 of the first area 810 and the vertex 822 of the second area 820, the amount of misalignment 1003 between the vertex 813 of the first area 810 and the vertex 823 of the second area 820, and the amount of misalignment 1004 between the vertex 814 of the first area 810 and the vertex 824 of the second area 820. The determination unit 330 determines that the first area 810 and the second area 820 are the same area when the average value of the amount of misalignment 1001, the amount of misalignment 1002, the amount of misalignment 1003, and the amount of misalignment 1004 is less than a predetermined threshold. On the other hand, the determination unit 330 determines that the first area 810 and the second area 820 are not the same area when the average value of the amount of misalignment 1001, the amount of misalignment 1002, the amount of misalignment 1003, and the amount of misalignment 1004 is equal to or more than the predetermined threshold.

The determination unit 330 may determine that the first area 810 and the second area 820 are not the same area when the maximum value among the amount of misalignment 1001, the amount of misalignment 1002, the amount of misalignment 1003, and the amount of misalignment 1004 is equal to or more than the predetermined threshold. The determination unit 330 may determine that the first area 810 and the second area 820 are the same area when the minimum value among the amount of misalignment 1001, the amount of misalignment 1002, the amount of misalignment 1003, and the amount of misalignment 1004 is less than a predetermined threshold. As described in connection with FIG. 11, the determination unit 330 may determine whether the first area 810 and the second area 820 are the same area based on the amount of misalignment of positions of one or more corresponding points between the first area 810 and the second area 820.

In connection with FIG. 9 and FIG. 11, an example of a method to determine whether the first area 810 and the second area 820 indicate the same area by calculating the degree to which the first area 810 overlaps with the second area 820 by using the respective four vertexes of the first area 810 and the second area 820 is described as a method to determine whether the first area 810 and the second area 820 are the same area. The determination unit 330 may determine whether the first area 810 and the second area 820 are the same area based on the two vertexes stored in the storage unit 380: the vertex 811 and the vertex 812, and the two vertexes included in the newly received risk area information: the vertex 821 and the vertex 822, without calculating the respective four vertexes of the first area 810 and the second area 820. The determination unit 330 may determine whether the first area 810 and the second area 820 are the same area based on the amount of misalignment between the positions of the center of gravity of the vertex 811 and the vertex 812 and the positions of the center of gravity of the two vertexes: the vertex 821 and the vertex 822. The determination unit 330 may determine whether the first area 810 and the second area 820 are the same area based on at least any of the average value, maximum value, or minimum value of the amount of misalignment between the positions of the vertex 811 and the vertex 821 and the amount of misalignment between the positions of the vertex 812 and the vertex 822.

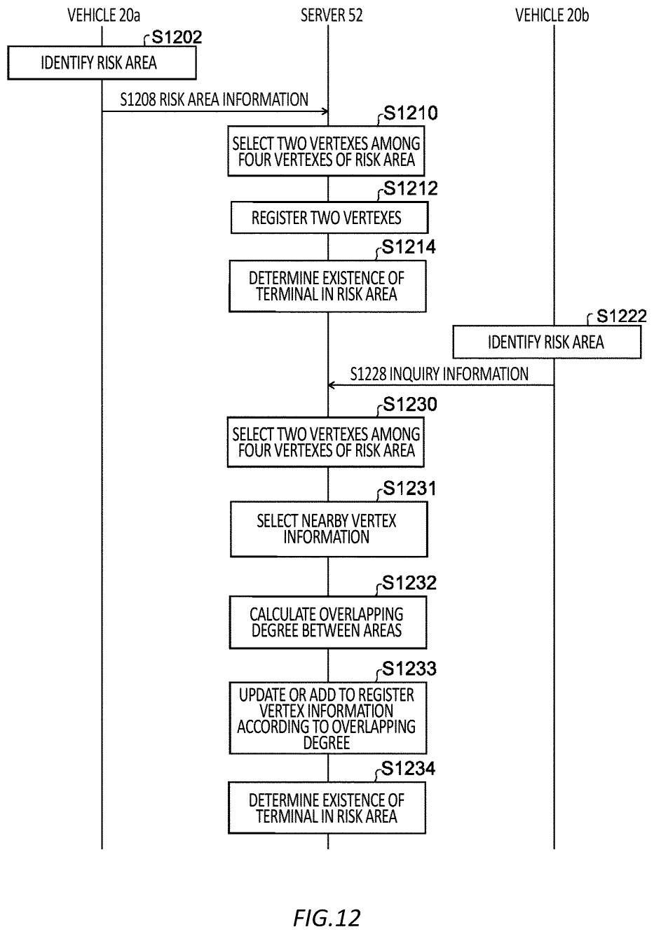

FIG. 12 schematically shows the process flow related to the information processing method performed by the vehicle 20a, the vehicle 20b, and the server 52. In S1202, the risk area identification unit 220a of the vehicle 20a identifies the risk area based on the information recognized by the sensor 29a. For example, the risk area identification unit 220a determines the four vertexes defining the risk area 110 based on the coordinate information that is acquired by the coordinate information acquisition unit 210a and is output by the sensor 29a. For example, the risk area identification unit 220a identifies the risk area by determining the four vertexes by the method described in connection with FIG. 7, FIG. 8, and the like.

In S1208, the transmission control unit 250a transmits to the server 52 the risk area information for inquiring whether a predetermined target exists in the risk area. The risk area information includes coordinate information of the four vertexes that define the risk area identified in S1202. The risk area information may include geographical coordinate information expressed by longitudes and latitudes of the four vertexes defining the risk area. The risk area information may include the information indicating the current position of the vehicle 20a or the travel direction of the vehicle 20a.

When the server 52 receives the risk area information transmitted from the vehicle 20a, in S1210, the retention control unit 310 selects two vertexes that meet a predetermined condition among four vertexes included in the risk area information based on the risk area information received through the control by the reception control unit 360. For example, the retention control unit 310 selects the two vertexes closest to the vehicle 20a among the four vertexes. Specifically, of the four vertexes, the retention control unit 310 may select the vertex 111 and the vertex 112 shown in FIG. 7, or may select the vertex 711 and the vertex 712 shown in FIG. 8.

In S1212, the retention control unit 310 registers coordinate information of the two vertexes selected in S1210 as vertex information of the risk area. For example, the retention control unit 310 causes the storage unit 380 to store the coordinate information of the two vertexes selected in S1210 as the vertex information of the risk area.

In addition, in S1214, the existence determination unit 320 determines whether the terminal 82 exists in the area defined by the four vertexes included in the risk area information received from the vehicle 20a. For example, in the situation shown in FIG. 1, the existence determination unit 320 determines that the terminal 82 does not exist in the area 110 defined by the four vertexes included in the risk area information. In this case, the transmission control unit 350 may not transmit the response information to the risk area information to the vehicle 20a. When the terminal 82 does not exist in the area defined by the four vertexes included in the risk area information, the transmission control unit 350 may transmit, to the vehicle 20a, the response information indicating that the target does not exist in the risk area.

Subsequently, in S1222, the risk area identification unit 220b of the vehicle 20b identifies the risk area based on the information recognized by the sensor 29b. For example, the risk area identification unit 220b determines the four vertexes defining the risk area 110′ based on the coordinate information that is acquired by the coordinate information acquisition unit 210b and is output by the sensor 29b. As the method for determining the vertex of the risk area, the same method as the method described in connection with FIG. 7, FIG. 8, and the like can be employed.

In S1228, the transmission control unit 250b transmits to the server 52 the risk area information for inquiring whether a predetermined target exists in the risk area. The risk area information includes coordinate information of the four vertexes that define the risk area identified in S1222. The risk area information may include geographical coordinate information expressed by longitudes and latitudes of the four vertexes defining the risk area. The risk area information may include the information indicating the current position of the vehicle 20b or the travel direction of the vehicle 20b.

When the server 52 receives the new risk area information transmitted from the vehicle 20b, in S1230, the determination unit 330 selects the two vertexes that meet the predetermined condition among the four vertexes included in the risk area information based on the risk area information received through the control by the reception control unit 360. For example, the determination unit 330 selects two vertexes closest to the vehicle 20b among the four vertexes.

In S1231, the determination unit 330 selects the vertex information closest to the positions of the two vertexes selected in S1230 among the vertex information that has already been stored in the storage unit 380. For example, the determination unit 330 selects the vertex information closest to the distance between the line segment connecting the two vertexes of the vertex information that has already been stored in the storage unit 380 and the line segment connecting the two vertexes selected in S1230.

In S1232, the determination unit 330 calculates the degree to which the first area based on the coordinate information of the two vertexes of the vertex information selected in S1231 overlaps with the second area based on the coordinate information of the two vertexes selected in S1230. For example, the determination unit 330 may calculate the degree of overlapping by the method described in connection with FIG. 9 to FIG. 11. In S1233, according to the degree of overlapping calculated by the determination unit 330, the retention control unit 310 updates the already stored vertex information with the vertex information of the two vertexes selected in S1230 or newly adds the vertex information of the two vertexes selected in S1230.

In S1234, the existence determination unit 320 determines whether the terminal 82 exists in the area defined by the four vertexes included in the risk area information received from the vehicle 20b. For example, in the situation shown in FIG. 2, the existence determination unit 320 determines that the terminal 82 does not exist in the area 120 defined by the four vertexes included in the risk area information. In this case, the transmission control unit 350 may not transmit the response information to the risk area information to the vehicle 20b. When the terminal 82 does not exist in the area defined by the four vertexes included in the risk area information, the transmission control unit 350 may transmit, to the vehicle 20b, the response information indicating that the target does not exist in the risk area.

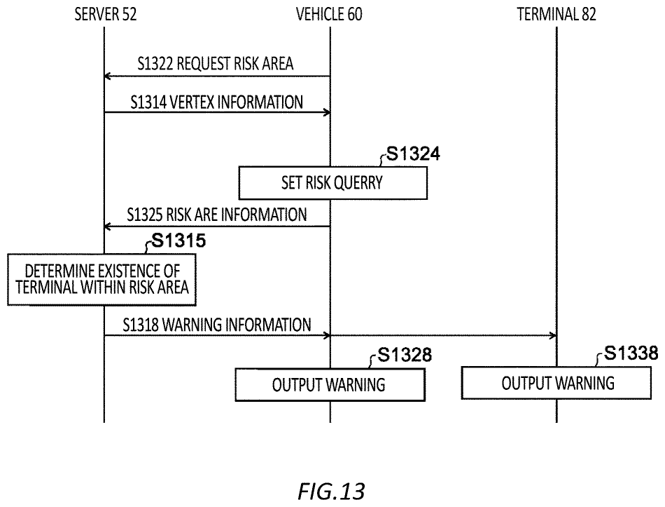

FIG. 13 schematically shows the process flow related to the information processing method performed by the server 52, the vehicle 60, and the terminal 82. The process in FIG. 13 is a process performed following FIG. 12.

In S1322, the information processing device 64 of the vehicle 60 transmits, to the server 52, the risk area request for requesting the positional information of the risk area. The risk area request may include information representing a position of the vehicle 60 and a travel direction of the vehicle 60. In S1314, the transmission control unit 350 causes, based on the risk area request, vertex information of a risk area present up ahead in the travel direction of the vehicle 60 out of the vertex information of the risk areas stored in the storage unit 380 to be transmitted to the vehicle 60.

In S1324, when determined that the vehicle 60 has approached a position represented by the vertex information based on the current position of the vehicle 60 and the vertex information received from the server 52, the information processing device 64 sets a risk area based on the two vertexes represented by the vertex information and the vehicle speed of the vehicle 60. For example, as described in connection with FIG. 4, the information processing device 64 determines the vertex 123 and the vertex 124 based on the distance L 2 between the coordinates of the two vertexes: vertex 111′ and the vertex 112′, and sets the area 120 defined by the vertex 111′, the vertex 112′, the vertex 123, and the vertex 124 as the risk area. In S1325, the information processing device 64 transmits the risk area information including the four vertexes of the risk area set in S1324 to the server 52.

When the server 52 receives the risk area information transmitted from the vehicle 60, in S1315, the existence determination unit 320 determines whether the terminal 82 exists in the area defined by the four vertexes included in the risk area information received from the vehicle 60. For example, in the situation shown in FIG. 4, the existence determination unit 320 determines that the terminal 82 exists in the area 120 defined by the four vertexes included in the risk area information. In this case, in S1318, the transmission control unit 350 causes warning information notifying that the terminal 82 is present in the area to be transmitted to the vehicle 60 as response information with respect to the inquiry information via the communication device 348. Further, the transmission control unit 350 causes warning information notifying that the vehicle is approaching to be transmitted to the terminal 82 via the communication device 348.

Upon receiving the warning information from the server 52, in S1328, the information processing device 64 outputs a warning with respect to the occupant of the vehicle 60 using the HMI function of the information output device 40. Further, upon receiving the warning information from the server 52, in S1338, the terminal 82 outputs a warning with respect to the person 80 using the HMI function of the terminal 82.

It is to be noted that for the communication between the information processing device 24 and the server 52, a communication method conforming to Cellular-V2X may be adopted. Cellular-V2X includes communication methods such as LTE-V2X PC5 and 5G-V2X PC5. In another embodiment, for the communication between the information processing device 24 and the server 52, a form that uses Wi-Fi (registered trademark) or DSRC (Dedicated Short Range Communications) may also be adopted. For the communication between the information processing device 24 and the server 52, any communication method other than Cellular-V2X, DSRC (registered trademark), and the like, such as Bluetooth (registered trademark), may be adopted. The information processing device 24 may communicate with the server 52 using a communication infrastructure of ITS (Intelligent Transport Systems).

It is to be noted that the vehicle 20 and the vehicle 60 are each an example of transportation equipment. The transportation equipment may include an automobile such as an occupant car and a bus, a saddle riding type vehicle, a bicycle, and the like. Moreover, although the system 10 functions as a system for performing warning when the terminal 82 is present in the risk area in the present embodiment described above, the system 10 may also function as a system for performing warning when any communication device other than the terminal 82, whose positional information can be managed by the server 52, is present. Such a communication device may be provided in any movable object such as an automobile, a saddle riding type vehicle, and a bicycle.

As a variation of the system 10 described above, an embodiment in which the information processing device 24 included in the vehicle 20 includes the function of the determination unit 330 included in the server 52 may be employed. For example, the transmission control unit 350 of the server 52 controls the communication device 348 to transmit, to the vehicle 20, the positional information of the two points of the risk area retained by the retention control unit 310 in the storage unit 380. In the information processing device 24 of the vehicle 20, the communication device 48 may receive the positional information transmitted from the server 52 and determine whether the first area closest to the new risk area identified by the risk area identification unit 220 matches the second area identified from the positional information of the two points of the new risk area, among one or more areas identified from the positional information received by the communication device 48.

When it is determined in the information processing device 24 that the first area matches the second area, the transmission control unit 250 of the information processing device 24 may transmit, to the server 52, the risk area update information including the positional information of the two points of the first area and the positional information of the two points of the new risk area identified by the risk area identification unit 220. When the communication device 348 of the server 52 receives the risk area update information, the retention control unit 310 of the server 52 may perform the control to update the positional information of the two points of the first area included in the risk area update information among the positional information stored in the storage unit 380 with the positional information of the two points of the new risk area included in the risk area update information.

When it is determined in the information processing device 24 that the first area does not match the second area, the transmission control unit 250 of the information processing device 24 may transmit, to the server 52, the risk area adding information including the positional information of the two points of the new risk area identified by the risk area identification unit 220. When the communication device 348 of the server 52 receives the risk area adding information, the retention control unit 310 of the server 52 may perform the control to newly retain the positional information of the two points of the new risk area included in the risk area adding information.

As described above, when the vehicle 20a and the vehicle 20b have a difference in the equipment performance of the vehicle to recognize the risk area or when there is a difference between the driving environment of the vehicle 20a and the driving environment of the vehicle 20b, or due to other reasons, the coordinate information recognized as a risk area may have a difference even when the same risk area is recognized. The present embodiment is constructed considering such a case and the purpose of the present embodiment is to suppress the decrease in the smoothness of the traffic while improving the safety of the traffic. Specifically, since the system 10 of the present embodiment can appropriately determine whether the risk areas transmitted from the vehicle 20a and the vehicle 20b are the same and update or add the coordinate information of the risk area, it can suppress the decrease in the smoothness of the traffic while improving the traffic safety.

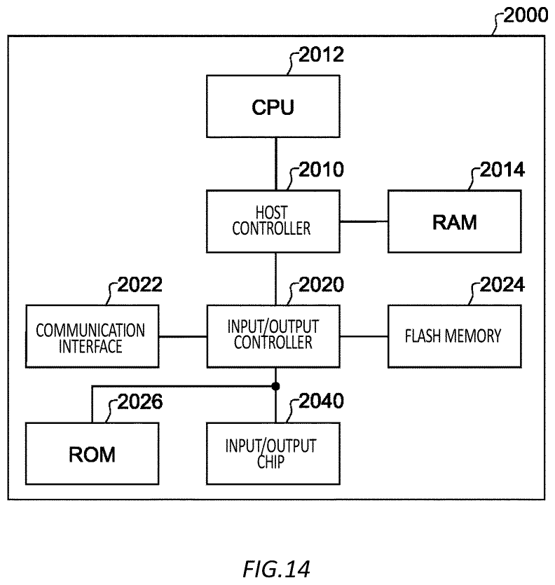

FIG. 14 shows an example of a computer 2000 in which a plurality of embodiments of the present invention may be entirely or partially embodied. The program installed on the computer 2000 can cause the computer 2000 to function as a device according to the embodiment such as the information processing device 24 and the server 52 or each unit of the device or as a system according to the embodiment such as a system 10 or each unit of the system, perform the operation associated with the device, each unit of the device, the system, or each unit of the system, and/or perform a process according to the embodiment or a step of the process. Such a program may be executed by a CPU 2012 in order to cause the computer 2000 to execute a particular operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to a program stored in the ROM 2026 and the RAM 2014 and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a computer-readable medium such as a CD-ROM, a DVD-ROM, or a memory card, or a network. The RAM 2014, the ROM 2026, or the flash memory 2024 is an example of the computer-readable medium. The programs are installed in the flash memory 2024, the RAM 2014, or the ROM 2026, and executed by the CPU 2012. Information processing written in these programs is read by the computer 2000 and provides cooperation between the programs and the various types of hardware resources described above. A device or a method may be composed by implementing operations or processing of information using the computer 2000.

For example, when the computer 2000 and an external device communicate with each other, the CPU 2012 may execute a communication program loaded in the RAM 2014, and instruct the communication interface 2022 to execute a communication process based on a process written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 to be read into the RAM 2014, and execute various types of processing on the data on the RAM 2014. Next, the CPU 2012 writes back the processed data into the recording medium.

Various types of information such as various types of programs, data, a table, and a database may be stored in the recording medium and subjected to information processing. The CPU 2012 may execute, on the data read from the RAM 2014, various types of processing including various types of operations, information processing, conditional judgment, conditional branching, unconditional branching, information retrieval/replacement, or the like described herein and designated by instruction sequences of the programs, and write back a result into the RAM 2014. In addition, the CPU 2012 may retrieve information in a file, a database, or the like in the recording medium. For example, when a plurality of entries each having an attribute value of a first attribute associated with an attribute value of a second attribute are stored in the recording medium, the CPU 2012 may retrieve an entry having a designated attribute value of the first attribute that matches a condition from among the plurality of entries, and read the attribute value of the second attribute stored in the entry, thereby acquiring the attribute value of the second attribute associated with the first attribute that satisfies a predetermined condition.

The program or software module described above may be stored in a computer-readable medium on the computer 2000 or near the computer 2000. A recording medium such as a hard disk or a RAM provided in a server system connected to a dedicated communication network or the Internet can be used as a computer-readable medium. The program stored in the computer-readable medium may be provided to the computer 2000 via the network.

When causing the computer 2000 to function as the control unit 200, a program that is installed in the computer 2000 and causes the computer 2000 to function as the control unit 200 may work on the CPU 2012 or the like to cause the computer 2000 to function as each unit of the control unit 200. Information processing written in these programs functions as each unit of the control unit 200 that is specific means by which software and the above-described various hardware resources cooperate by being read by the computer 2000. Then, by the specific means realizing calculation or processing of information according to a purpose of use of the computer 2000 in the present embodiment, the unique control unit 200 according to the purpose of use is constructed.

When causing the computer 2000 to function as the control unit 300, a program that is installed in the computer 2000 and causes the computer 2000 to function as the control unit 300 may work on the CPU 2012 or the like to cause the computer 2000 to function as each unit of the control unit 300. Information processing written in these programs functions as each unit of the control unit 300 that is specific means by which software and the above-described various hardware resources cooperate by being read by the computer 2000. Then, by the specific means realizing calculation or processing of information according to a purpose of use of the computer 2000 in the present embodiment, the unique control unit 300 according to the purpose of use is constructed.

Various embodiments have been described with reference to the block diagrams and the like. In the block diagrams, each block may represent (1) a step of a process in which an operation is executed, or (2) each unit of the device having a role in executing the operation. Certain steps and each unit may be implemented by dedicated circuit, programmable circuit supplied with computer-readable instructions stored on computer-readable media, and/or processors supplied with computer-readable instructions stored on computer-readable media. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element such as a flip-flop, a register, a field programmable gate array (FPGA), a programmable logic array (PLA), or the like.

A computer-readable medium may include any tangible device that can store instructions to be executed by a suitable device, and as a result, the computer-readable medium having the instructions stored thereon constitutes at least a part of an article of manufacture including instructions which can be executed to create means for performing operations specified in the processing procedures or block diagrams. Examples of the computer-readable medium may include an electronic storage medium, a magnetic storage medium, an optical storage medium, an electromagnetic storage medium, a semiconductor storage medium, and the like. More specific examples of the computer-readable medium may include a FLOPPY (registered trademark) disk, a diskette, hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disc (DVD), a BLU-RAY (registered trademark) disc, a memory stick, an integrated circuit card, or the like.

The computer-readable instructions may include an assembler instruction, an instruction-set-architecture (ISA) instruction, a machine instruction, a machine dependent instruction, a microcode, a firmware instruction, state-setting data, or either of source code or object code written in any combination of one or more programming languages including an object oriented programming language such as Smalltalk (registered trademark), JAVA (registered trademark), and C++, and a conventional procedural programming language such as a “C” programming language or a similar programming language.

Computer-readable instructions may be provided to a processor of a general purpose computer, a special purpose computer, or another programmable data processing device, or to programmable circuit, locally or via a local area network (LAN), a wide area network (WAN) such as the Internet, and a computer-readable instruction may be executed to provide means for executing operations designated in the described processing procedures or block diagrams. Examples of the processor include a computer processor, a processing unit, a microprocessor, a digital signal processor, a controller, a microcontroller, and the like.

While the present invention has been described by way of the embodiments, the technical scope of the present invention is not limited to the above-described embodiments. It is apparent to persons skilled in the art that various alterations or improvements can be made to the above-described embodiments. It is also apparent from the description of the claims that the embodiments to which such alterations or improvements are made can be included in the technical scope of the present invention.

Note that the order of execution of each process such as operations, procedures, steps, stages in the device, system, program, and method shown in the claims, specification, and diagrams can be realized in any order as long as the order is not specifically indicated by “prior to,” “before,” or the like and also as long as the output from a previous process is not used in a later process. Even if the operational flow is described by using phrases such as “first” or “next” in the claims, specification, or diagrams for convenience, it does not necessarily mean that the process must be performed in this order.

### EXPLANATION OF REFERENCES

10 system;
20, 60, 90 vehicle;
21 radar;
22 camera;
24 information processing device;
25 GNSS reception unit;
26 vehicle speed sensor;
29 sensor;
40 information output device;
48 communication device;
50 base station;
52 server;
64 information processing device;
70 road;
80 person;
82 terminal;
110, 120: area;
111, 112, 113, 114, 123, 124 vertex;
200 control unit;
208 control unit;
210 coordinate information acquisition unit;
220 risk area identification unit;
250 transmission control unit;
260 reception control unit;
280 storage unit;
300 control unit;
310 retention control unit;
320 existence determination unit;
330 determination unit;
348 communication device;
350 transmission control unit;
360 reception control unit;
380 storage unit;
601, 602, 603, 701, 702, 703: position;
710 area;
711, 712, 713, 714 vertex;
810 first area;
820 second area;
830 area;
811, 812, 813, 814 vertex;
821, 822, 823, 824 vertex;
815, 825 position of the center of gravity;
1001, 1002, 1003, 1004 amount of misalignment;
2000 computer;
2010 host controller;
2012 CPU;
2014 RAM;
2020 input/output controller;
2022 communication interface;
2024 flash memory;
2026 ROM;
2040 input/output chip.

What is claimed is:

1. A system comprising:
a risk area identification unit which identifies a risk area external to a movable object;
a retention control unit which performs control to retain positional information of two points of the risk area; and
a determination unit which determines whether a first area identified from the positional information of the two points that has already been retained through control by the retention control unit matches a second area identified from positional information of two points of a new risk area when the risk area identification unit identifies the new risk area;
wherein the retention control unit performs control to update the positional information of the two points that has already been retained with the positional information of the two points of the new risk area when the determination unit determines that the first area matches the second area.

2. A system comprising:
a risk area identification unit which identifies a risk area external to a movable object;
a retention control unit which performs control to retain positional information of two points of the risk area; and
a determination unit which determines whether a first area identified from the positional information of the two points that has already been retained through control by the retention control unit matches a second area identified from positional information of two points of a new risk area when the risk area identification unit identifies the new risk area,
wherein the retention control unit performs control to newly retain the positional information of the two points of the new risk area when the determination unit determines that the first area does not match the second area.

3. The system according to claim 1, wherein the retention control unit performs control to newly retain the positional information of the two points of the new risk area when the determination unit determines that the first area does not match the second area.

4. The system according to claim 1, wherein when the risk area identification unit identifies a new risk area,
the retention control unit determines positional information of a first plurality of points defining the first area based on the positional information of the two points that has already been retained and determines positional information of a second plurality of points defining the second area based on positional information of two points of the new risk area, and
the determination unit determines whether the first area matches the second area based on a degree to which the first area defined by the first plurality of points overlaps with the second area defined by the second plurality of points.

5. The system according to claim 1, wherein the determination unit determines whether the first area matches the second area based on an overlapping area of the first area and the second area.

6. The system according to claim 5, wherein the determination unit determines whether the first area matches the second area based on an area ratio of a partial area where the first area and the second area overlap to at least one of the first area or the second area.

7. The system according to claim 1, wherein the determination unit determines whether the first area matches the second area based on an amount of misalignment between a position of a center of gravity of the first area and a position of a center of gravity of the second area.

8. The system according to claim 1, wherein the determination unit determines whether the first area matches the second area based on an amount of misalignment between a plurality of points defining the first area and a plurality of points defining the second area.

9. The system according to claim 8, wherein the determination unit determines whether the first area matches the second area based on at least one of an average value, a maximum value, or a minimum value of an amount of misalignment between a plurality of points defining the first area and a plurality of points defining the second area.

10. The system according to claim 1, comprising a transmission control unit which performs control to transmit, to another movable object, positional information of two points retained by the retention control unit.

11. The system according to claim 1, wherein the system includes the movable object and a server external to the movable object;
the server includes the retention control unit; and
the movable object includes the risk area identification unit, a positional information reception unit that receives, from the server, the positional information retained by the retention control unit, and the determination unit.

12. The system according to claim 1, wherein the system includes the movable object and a server external to the movable object,
the movable object includes the risk area identification unit, and
the server includes the retention control unit, a reception control unit which performs control to receive risk area information indicating a risk area external to the movable object identified by the movable object, and the determination unit.

13. The system according to claim 12, wherein the server is a mobile edge computing (MEC) server.

14. The system according to claim 1, wherein the movable object is a vehicle.

15. The system according to claim 2, wherein when the risk area identification unit identifies a new risk area,
the retention control unit determines positional information of a first plurality of points defining the first area based on the positional information of the two points that has already been retained and determines positional information of a second plurality of points defining the second area based on positional information of two points of the new risk area, and
the determination unit determines whether the first area matches the second area based on a degree to which the first area defined by the first plurality of points overlaps with the second area defined by the second plurality of points.

16. The system according to claim 3, wherein when the risk area identification unit identifies a new risk area,
the retention control unit determines positional information of a first plurality of points defining the first area based on the positional information of the two points that has already been retained and determines positional information of a second plurality of points defining the second area based on positional information of two points of the new risk area, and
the determination unit determines whether the first area matches the second area based on a degree to which the first area defined by the first plurality of points overlaps with the second area defined by the second plurality of points.

17. The system according to claim 2, wherein the determination unit determines whether the first area matches the second area based on an overlapping area of the first area and the second area.

18. The system according to claim 3, wherein the determination unit determines whether the first area matches the second area based on an overlapping area of the first area and the second area.

19. The system according to claim 18, wherein the determination unit determines whether the first area matches the second area based on an area ratio of a partial area where the first area and the second area overlap to at least one of the first area or the second area.

20. A method comprising:
identifying a risk area external to a movable object;
performing control to retain positional information of two points of the risk area;
identifying new risk area information;
determining whether a first area identified from the positional information of the two points that has already been retained matches a second area identified from positional information of two points of a risk area indicated by the new risk area information; and
performing control to update the positional information of the two points that has already been retained with positional information of two points of the new risk area when it is determined that the first area matches the second area.
